(19) United States
(12) Patent Application Publication
(10) Pub. No.: US 2019/0282948 A1
(43) Pub. Date: Sep. 19, 2019

(54) SEMICONDUCTOR PROCESSING SYSTEM

(71) Applicant: Imad Mahawili, Roseville, CA (US)

(72) Inventor: Imad Mahawili, Roseville, CA (US)

(21) Appl. No.: 16/071,356

(22) PCT Filed: Jan. 25, 2017
(86) PCT No.: PCT/US2017/014815

§ 371 Date: Jul. 19, 2018

Related U.S. Application Data
(60) Provisional application No. 62/287,671, filed on Jan. 27, 2016.
(60) Provisional application No. 62/292,598, filed on Feb. 8, 2016.

(51) Int. Cl. B01D 53/00; B01D 53/38; B01D 53/78; B01D 53/75

(52) U.S. Cl. CPC B01D 53/002; B01D 53/005; B01D 2258/0216; B01D 53/78; B01D 53/75; B01D 53/38

(57) ABSTRACT

A semiconductor processing system includes a semiconductor processing chamber, a scrubber, an exhaust line in fluid communication with the chamber and the scrubber for delivering exhaust from the chamber to the scrubber, and a steam generation device in fluid communication with the exhaust line for injecting steam into the exhaust line.

### CROSS-REFERENCE TO RELATED APPLICATIONS

This application is a 371 of PCT Application Ser. No. PCT/US2017/014815 filed Jan. 25, 2017, by inventor Imad Mahawili and entitled SEMICONDUCTOR PROCESSING SYSTEM, which claims priority to U.S. provisional patent application Ser. No. 62/287,671 filed Jan. 27, 2016 and U.S. provisional patent application Ser. No. 62/292,598 filed Feb. 8, 2016, by inventor Imad Mahawili and entitled SEMICONDUCTOR PROCESSING SYSTEM, the complete disclosures of which are incorporated herein by reference.

### TECHNICAL FIELD AND BACKGROUND OF THE INVENTION

Thermal and plasma enhanced chemical vapor deposition processes are employed in the fabrication of semiconductor devices. These processes and thin layer etching technologies together with chamber plasma clean processes all have environmentally undesirable chamber exhaust byproducts that must be abated using commercial scrubbing burners and water scrubbers. The semiconductor processing chamber is not one hundred percent efficient; therefore, the chamber exhaust contains some gas fractions of the chamber feed gases plus the reaction by-products.

For example, in a tungsten silicide deposition chamber, the chamber feed gases are silane and tungsten hexafluoride at reduced pressure. In a typical silicon nitride film deposition process, silane and ammonia are the chamber feed gases. In a conformal dielectric thin film deposition process, a mixture of ozone and oxygen are fed together with tetraethyl orthosilicate (TEOS) vapor into a chamber employing plasma enhancement at reduced pressure. Nitrogen trifluoride, hydrogen fluoride, and fluorine gases are often used for pre and or post chamber plasma cleaning to achieve the required deposited thin film quality.

Commercial scrubbers used to abate the effluent gases from semiconductor processes use natural gas burners to thermally dissociate unreacted molecules into silicon dioxide, carbon dioxide, tungsten oxide, and other oxide particles that can ultimately be removed from the gas stream using electrostatic precipitators prior to any final vent to the atmosphere. Water is also used in these scrubbers to dissolve water soluble byproducts such as hydrogen fluoride and collect some of the solid oxide particles. This water waste stream is then neutralized using sodium or potassium hydroxide prior to discharge in the waste water system of the plant.

Further, to dilute the gas phase concentration of unreacted gases, such as TEOS, oxygen and ozone, in the chamber exhaust, and prevent any deflagration or detonation (by eliminating the probability of achieving a permissible ratio of between 0.5-to-0.7 of the lower flammability limit of, in this example, TEOS), nitrogen is added to the vacuum pump exhaust stream. However, the addition of nitrogen increases the operations cost and puts technical constraints on the existing commercial scrubbing systems as their performance is limited by the maximum allowed gas handling flowrate. Further, as wafer diameters increase from the current 300 mm to 450 mm, the use of significantly larger nitrogen flowrates may prove to be cost prohibitive as the current scrubbing technologies are scaled up to process such large dilution volumes.

Accordingly, there is a need for a system that can reduce, if not eliminate, the need for a nitrogen dilution stream.

### SUMMARY

In one embodiment, a semiconductor processing system includes a semiconductor processing chamber, a scrubber, and an exhaust line in fluid communication with the chamber and the scrubber for delivering exhaust from the chamber to the scrubber. The system further includes a steam generation device in fluid communication with the exhaust line for injecting steam into the exhaust line.

In one aspect, the steam generation device comprises a steam generator for generating saturated or super-heated steam for injecting into the exhaust line.

In another aspect, the system includes a heat exchanger downstream of the steam generating device to convert the exhaust steam into a liquid and a gas and to direct the gas to the scrubber and the liquid to a waste effluent stream of the scrubber.

In other aspects, an additive supply is in fluid communication with the steam generator for supplying an additive to the steam. Suitable additives include organic or inorganic acids or bases volatilize by an inert stream or by the steam. Additives could also include electron injection stream or a plasma of steam or plasma of superheated steam.

In a further aspect, the exhaust line includes a pump between the chamber and the scrubber for pumping exhaust from the chamber to the scrubber. The steam generating device is in fluid communication with the exhaust line downstream of the pump.

In yet a further aspect, the system includes a steam injector for injecting the steam from the steam generating device into the exhaust line. Optionally, the steam injector injects steam into the exhaust line in, at, or near the pump or the pump outlet.

According to other aspects, the system includes a heat source for heating exhaust line. For example, a suitable heat source includes heating tape or tapes applied to the exterior of the exhaust line.

According to yet another aspect, the system also includes a nitrogen dilution supply in selective fluid communication with the exhaust line.

In another embodiment, a method of reducing the unreacted gases in the exhaust of a semiconductor chamber includes injecting steam into the exhaust and then condensing the exhaust steam (exhaust with added steam) into a condensed exhaust before directing at least the gas stream of the condensed exhaust to a scrubber.

In one aspect, the water stream of the condensed exhaust is directed to a waste water effluent stream of the scrubber.

In one aspect, superheated steam is injected into the exhaust.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and is capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DETAILED DESCRIPTION OF THE DRAWINGS

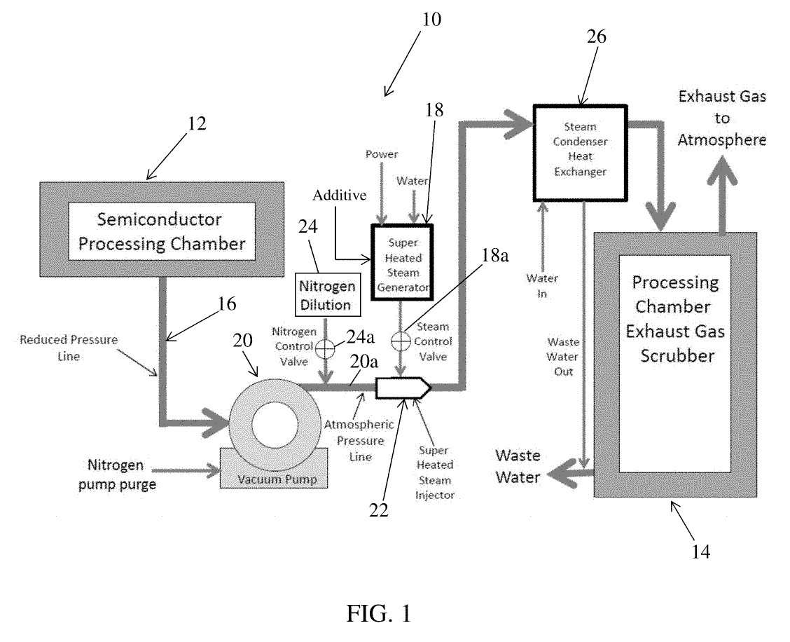

Referring to FIG. 1, the numeral 10 generally designates a semiconductor processing system. Semiconductor processing system 10 includes a semiconductor processing chamber 12, a scrubber 14, such as a burn/wet scrubber, and an exhaust line 16 in fluid communication with the chamber and the scrubber for delivering exhaust from the chamber to the scrubber. System 10 further includes a steam generation device 18 in fluid communication with the exhaust line 16 for injecting steam into the exhaust line to dilute the gas phase concentration of unreacted gases, such as TEOS, oxygen and ozone, in the exhaust from the chamber.

By reducing the gas phase concentration of unreacted gases in the exhaust from the chamber, system 10 can reduce, if not prevent, any deflagration or detonation by eliminating the probability of achieving a permissible ratio of the lower flammability limit of the unreacted gas or gases in the exhaust. For example, for TEOS the permissible ratio is between 0.5-to-0.7 of the lower flammability limit (LFL) of TEOS. The lower flammability limit, LFL, of TEOS is 0.9% of total flowrate in air. In other processes, for example, LFL for silane is at 1.37%, ammonia is at 15%, hydrogen is 4%, and methane is 5.3%. As a result, system 10 can reduce, if not eliminate, the need for a nitrogen dilution stream.

Referring again to FIG. 1, exhaust line 16 includes a pump 20, such as vacuum pump, which optionally comprises a two stage pump. The pressure in the portion of the exhaust line connecting the chamber to the pump is the processing pressure. For example, in a typical TEOS oxidation process, the line pressure is in a range of 100 to 500 and optionally around 300 milli Torr (mTorr). The pump uses a purge flowrate, such as a nitrogen purge flow rate, of approximately 50 standard liters per minute (slm) as it compresses the chamber exhaust line pressure to near one atmosphere. As will be described below, steam is introduced to dilute the gas phase concentration of unreacted gas or gases.

In the illustrated embodiment, steam generation device 18 comprises a steam generator that generates saturated or super-heated steam. The steam from steam generation device 18 is controlled by a control valve 18a and is selectively injected into the exhaust line 16 by a steam injector 22, such as a stainless steel steam injector. In the illustrated embodiment, steam injector 22 is located at, or slightly downstream, of the pump outlet 20a. Alternately, steam injector 22 may be located in, at, or slightly downstream, of the pump or the pump outlet 20a.

A suitable conventional steam generator may be used, such as is available from Micropyretics Heaters International, Bayzi Corporation Mighty Steam generators or others, and used to produce steam, such as saturated or superheated steam, at a controlled temperature between about 150 C and about 700 C and at a wide range of flowrates, from as low as about 100 slm to as high as about 1000 slm. Specific steam flowrates and temperatures can be chosen and optimized for each semiconductor process. The steam flow rate dilutes the pump exhaust stream and, therefore, prevents any of the pump exhaust byproducts from reaching the permitted LFL percentage in the near-atmospheric pump exhaust pressure line. In the typical TOES process, superheated steam will be injected at a rate of approximately 150 slm or higher to replace the nitrogen dilution.

Further, in the illustrated embodiment system 10 may include a nitrogen dilution supply 24 and nitrogen control valve 24a. For example, when retrofitting an existing semiconductor processing system, the nitrogen dilution supply may be left in place. Rather than operating at all times, the nitrogen dilution supply may be turned off by closing controlling valve 24a when the steam is injected into the exhaust line but then turned on by opening controlling valve 24a and used on an as needed basis, such as for cleaning or inerting purposes using a very low flowrate to purge the process lines.

As best seen in FIG. 1, system 10 includes a heat exchanger 26 downstream of the steam generating device to convert the exhaust steam into a liquid and a gas. At a certain distance, for example 30 feet, downstream from the process vacuum pump and immediately prior to the commercial scrubber, this chamber exhaust stream (chamber exhaust stream with its added superheated steam) will be injected into heat exchanger 26 as shown. For example, the heat exchanger 26 may comprise a single direct water heat exchanger. The heat exchanger condenses the superheated exhaust steam into liquid water and vents a gas stream of a composition nearly that of the pump exhaust stream prior to the superheated steam injection. The condensed water stream of the exhaust steam (exhaust with its added steam) is sent to the waste water effluent stream of the scrubber. The gas stream of the exhaust steam is injected immediately into the burn box of the scrubber.

While there might be some gas phase reactions between the superheated steam and the chamber/pump exhaust gas molecules, which only reduce the reactants gas phase concentration of such harmful compounds, the use of this superheated steam is to first eliminate the need of costly heated nitrogen to achievement of the 0.5-0.7 of the LFL and subsequently removing some of the byproducts via gas phase reactions. The cost savings of this novel application in current semiconductor fabrication facilities could be extremely significant as well as enabling and the near future scale up to 450 mm wafer diameter processes.

In other aspects, an additive supply is in fluid communication with the steam generator for supplying an additive to the steam. Suitable additives include organic or inorganic acids or bases volatilize by an inert stream or by the steam. The additives may catalyze or suppress certain gas phase reactions depending on the specific semiconductor process and its byproducts. Additives could also include electron injection stream or a plasma of steam or plasma of superheated steam.

Optionally, the system includes a heat source for heating the exhaust line. The entire length of the pump exhaust line may be heated and maintained at an elevated temperature. For example, the vacuum pump exhaust line may be heated, in this TEOS oxidation process example, to between 150-170 degrees Celsius to prevent any condensation of the TEOS or reaction byproducts which can subsequently lead to particulate clogging of the exhaust pipes. Suitable heat sources include heating tape or tapes applied to the exterior of the exhaust line.

Accordingly, the present system provides a method of reducing the unreacted gases in the exhaust of a semiconductor chamber by injecting steam into the exhaust from the chamber and then condensing the exhaust with the added steam before directing at least the gas stream of the condensed exhaust to a scrubber. The condensed water stream of the condensed exhaust can then be directed to a waste water effluent stream of the scrubber.

While several embodiments have been shown and described, the above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert but which can be used independently and/or combined with other features. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

I claim:

1. A semiconductor processing system comprising:
a semiconductor processing chamber;
a scrubber;
an exhaust line in fluid communication with the chamber and the scrubber for delivering exhaust from the chamber to the scrubber; and
a steam generation device in fluid communication with the exhaust line for injecting steam into the exhaust line.

2. The system according to claim 1, wherein the steam generation device comprises a steam generator for generating saturated or super-heated steam for injection into the exhaust line.

3. The system according to claim 2, further comprising a heat exchanger downstream of the steam generation device to convert the steam into a liquid and a gas.

4. The system according to claim 3, wherein the scrubber generates a waste effluent stream, and the heat exchanger is configured to direct the gas to the scrubber and the liquid to the waste effluent stream of the scrubber.

5. The system according to claim 1, further comprising an additive supply in fluid communication with the steam generation device for supplying an additive to the steam.

6. The system according to claim 5, wherein the additive supply is configured to supply (1) an electron injection stream or (2) a plasma of steam or 3) a plasma of superheated steam.

7. The system according to claim 1, further comprising a pump between the chamber and the scrubber for pumping exhaust from the semiconductor processing chamber to the scrubber.

8. The system according to claim 7, wherein the steam generation device is in fluid communication with the exhaust line downstream of the pump.

9. The system according to claim 1, further comprising a steam injector for injecting the steam from the steam generation device into the exhaust line.

10. The system according to claim 9, wherein the pump includes a pump outlet, the steam injector operable to inject steam into the exhaust line in, at, or near the pump or the pump outlet.

11. The system according to claim 1, further comprising a heat source to heat the exhaust line.

12. The system according to claim 11, wherein the exhaust line has an exterior, and the heat source comprises a heating tape or tapes applied to the exterior of the exhaust line.

13. The system according to claim 1, further comprising a nitrogen dilution supply in selective fluid communication with the exhaust line.

14. A method of reducing unreacted gases in the exhaust of a semiconductor chamber, the method comprising:
injecting steam into the exhaust of a semiconductor chamber to form exhaust steam;
condensing the exhaust steam into a condensed exhaust;
after condensing, directing at least a gas stream of the condensed exhaust to a scrubber.

15. The method according to claim 14, further comprising directing a water stream of the condensed exhaust to a waste water effluent stream of the scrubber.

16. The method according to claim 14, wherein the injecting steam includes injecting superheated steam into the exhaust.

17. The method according to claim 16, wherein the injecting steam includes injecting superheated steam into the exhaust.
